(19) United States
(12) Patent Application Publication
(10) Pub. No.: US 2021/0252962 A1
(43) Pub. Date: Aug. 19, 2021

(54) VEHICLE DRIVING APPARATUS

(71) Applicant: HONDA MOTOR CO., LTD., Tokyo (JP)

(72) Inventors: Keita YANO, Wako-shi (JP); Norikazu KAWAI, Wako-shi (JP); Toru UBUKATA, Wako-shi (JP)

(21) Appl. No.: 17/171,035

(22) Filed: Feb. 9, 2021

(30) Foreign Application Priority Data
Feb. 18, 2020 (JP) 2020-025384

(51) Int. Cl. B60K 6/24; B60K 6/26; B60K 6/38; B60K 6/36; F16C 3/02; F16H 57/021; F16C 19/54

(52) U.S. Cl. CPC B60K 6/24; B60K 6/26; B60K 6/38; F16H 2057/02043; F16C 3/023; F16H 57/021; F16C 19/54; B60K 6/36

(57) ABSTRACT

An apparatus includes a generator, a case, a first bearing configured to rotatably support a rotating shaft of the generator on a side of one end portion, and a second bearing configured to rotatably support the rotating shaft on a side of the other end portion. The case includes a first wall portion that forms an accommodation space, and a second wall portion that covers an end portion of the first wall portion. The first bearing is supported by the second wall portion. The rotating shaft includes an input portion on a side of the other end portion of the second bearing, and a transmission portion configured to transmit, to the second bearing, a thrust load of the rotating shaft acting from the other end portion toward the one end portion.

### CROSS-REFERENCE TO RELATED APPLICATION(S)

This application claims priority to and the benefit of Japanese Patent Application No. 2020-025384 filed on Feb. 18, 2020, the entire disclosure of which is incorporated herein by reference.

### BACKGROUND OF THE INVENTION

### Field of the Invention

The present invention relates to a vehicle driving apparatus having a power generation function.

### Description of the Related Art

There have been proposed a vehicle driving apparatus equipped with a generator that generates power by a driving force of an engine and a traction motor (Japanese Patent No. 6078486). In a driving apparatus 100 disclosed in Japanese Patent No. 6078486, a generator 60 and a motor 70 are accommodated in a case 80. The case 80 includes a motor case 81 that forms the main body thereof and a side cover 82 that covers an opening portion of the motor case 81. A bearing 62 that supports an end portion of a motor generator shaft 2 is supported by the side cover 82.

In the driving apparatus as described in Japanese Patent No. 6078486, due to the torque fluctuation of the engine, a load in the thrust direction repeatedly acts on the motor generator shaft 2. When the motor generator shaft 2 pulsates in the axial direction due to this thrust load, the pulses propagate to the side cover 82 via the bearing 62. Since the side cover 82 is a plate-shaped member, it may vibrate and generate noise.

### SUMMARY OF THE INVENTION

It is an object of the present invention to provide a vehicle driving apparatus that can reduce vibration of a wall portion which corresponds to a cover and supports the bearing of a rotating shaft.

According to an aspect of the present invention, there is provided a vehicle driving apparatus comprising: a generator configured to generate power by a driving force of an engine; a case configured to accommodate the generator; a first bearing configured to rotatably support a rotating shaft of the generator on a side of one end portion of the rotating shaft; and a second bearing configured to rotatably support the rotating shaft on a side of the other end portion of the rotating shaft, wherein the case includes a first wall portion that forms an accommodation space of the generator, and a second wall portion that covers an end portion of the first wall portion, the first bearing is supported by the second wall portion, the second bearing is supported by the first wall portion, and the rotating shaft includes an input portion located on a side of the other end portion of the second bearing and to which a driving force of the engine is input, and a transmission portion configured to transmit, to the second bearing, a thrust load of the rotating shaft acting from the other end portion toward the one end portion.

Further features of the present invention will become apparent from the following description of exemplary embodiments (with reference to the attached drawings).

### BRIEF DESCRIPTION OF THE DRAWINGS

FIG. 1 a block diagram of a vehicle driving apparatus according to an embodiment of the present invention;

FIG. 2 is a sectional view showing the structure around a generator of the vehicle driving apparatus shown in FIG. 1;

FIG. 3 is a block diagram showing a vehicle driving apparatus according to another embodiment of the present invention;

FIG. 4 is a sectional view showing the structure around a generator of the vehicle driving apparatus shown in FIG. 3; and

FIG. 5 is a sectional view showing another example of the structure around the generator.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

<Outline>

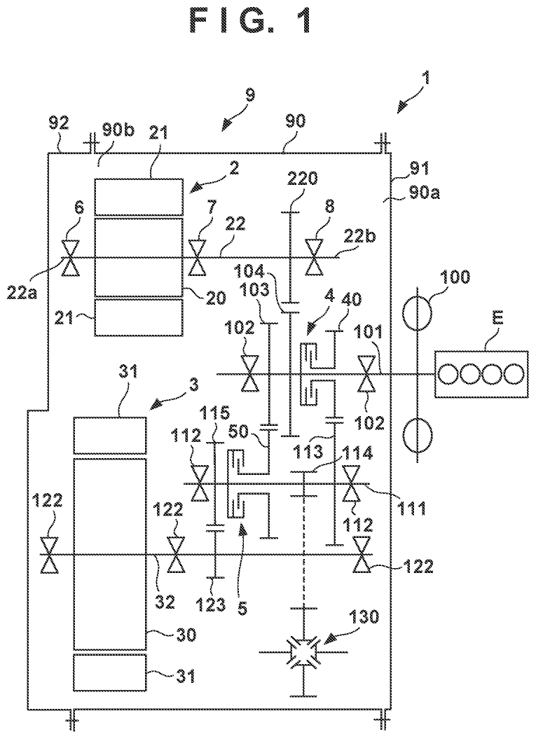

FIG. 1 is a block diagram of a driving apparatus 1 according to an embodiment of the present invention. The driving apparatus 1 is a vehicle driving apparatus mounted on a vehicle such as a four-wheeled vehicle, and is accommodated in a case 9. The driving apparatus 1 includes an input shaft 101 to which a driving force of an engine E is input via a flywheel 100. The engine E is, for example, an internal combustion engine such as a 4-cycle multi-cylinder engine.

The input shaft 101 is rotatably supported by a plurality of bearings 102. The input shaft 101 is provided with gears 103 and 104, and the gears 103 and 104 constantly rotate integrally with the input shaft 101. Further, a gear 40 is provided connectably/disconnectably to the input shaft 101 via a clutch 4. When the clutch 4 is set in a connected state, the gear 40 rotates integrally with the input shaft 101.

The driving apparatus 1 includes a counter shaft 111. The counter shaft 111 is rotatably supported by a plurality of bearings 112. The counter shaft 111 is provided with gears 113 to 115, and the gears 113 to 115 constantly rotate integrally with the input shaft 101. The gear 113 meshes with the gear 40. Further, a gear 50 is provided connectably/disconnectably to the counter shaft 111 via a clutch 5. When the clutch 5 is set in a connected state, the gear 50 rotates integrally with the counter shaft 111. The gear 50 meshes with the gear 103.

The driving apparatus 1 includes a differential apparatus 130. The driving force is transmitted to the differential apparatus 130 via the gear 114 on the axis of the counter shaft 111. The differential apparatus 130 transmits the driving force to left and right wheels (driving wheels) of the vehicle to rotate the driving wheels.

When the clutch 4 is connected, the driving force of the engine E is transmitted to the differential apparatus 130 via the gears 40, 113, and 114, and the driving force of the engine E is used for traveling of the vehicle. Further, when the clutch 5 is connected, the driving force of the engine E is transmitted to the differential apparatus 130 via the gears 103, 50, and 114, and the driving force of the engine E is used for traveling of the vehicle. The gear ratio obtained when the clutch 4 is connected is higher than the gear ratio obtained when the clutch 5 is connected. That is, the clutch 4 is a Low-side clutch, and the clutch 5 is a High-side clutch. By providing the clutches 4 and 5, it is possible to implement two gear ratios in traveling of the vehicle using the driving force of the engine E. In this respect, the driving apparatus 1 can also be called a transmission.

The driving apparatus 1 includes a generator 2 that generates power by the driving force of the engine E. In this respect, the driving apparatus 1 can also be called a power generation apparatus. The generator 2 is a generator motor including a rotor 20 and stator 21. The generator 2 can also be used as a starter motor for starting the engine E. The rotor 20 is, for example, a permanent magnet, and the stator 21 is, for example, an electromagnet. The generator 2 includes a rotating shaft 22 with the rotor 20 fixed thereto, and the rotor 20 and the rotating shaft 22 integrally rotate. The rotating shaft 22 is rotatably supported by a plurality of bearings 6 to 8. The rotating shaft 22 is provided with an input portion 220 to which the driving force is input. In this embodiment, the input portion 220 is a gear that meshes with the gear 104.

During driving of the engine E, the driving force thereof is input to the rotating shaft 22 via the input shaft 101, the gear 104, and the input portion 220 to rotate the rotating shaft 22. This causes the generator 21 to generate power.

The driving apparatus 1 includes a traction motor 3 that exerts a driving force to be transmitted to the left and right wheels (driving wheels) of the vehicle. In this respect, the driving apparatus 1 can also be called an electric driving apparatus. The traction motor 3 includes a rotor 30 and a stator 31. The rotor 30 is, for example, a permanent magnet, and the stator 31 is, for example, an electromagnet. The traction motor 3 includes a rotating shaft 32 with the rotor 30 fixed thereto, and the rotor 30 and the rotating shaft 32 integrally rotate. The rotating shaft 32 is rotatably supported by a plurality of bearings 122. The rotating shaft 32 is provided with a gear 123 that outputs a driving force of the traction motor 3. The gear 123 constantly rotates integrally with the rotating shaft 32. The gear 123 meshes with the gear 115. The driving force of the traction motor 3 is input to the differential apparatus 130 via the gear 123, the gear 115, the counter shaft 111, and the gear 114 to rotate the left and right wheels (driving wheels) of the vehicle.

The case 9 broadly includes a wall portion 90, a wall body 91 on the engine E side, and a wall portion 92 on the opposite side of the engine E. The wall body 91 and the wall portion 92 are fastened to the wall portion 90 by a plurality of bolts. In this embodiment, the wall portion 90 is one member, but it may be formed by a plurality of members. The wall portion 90 is a hollow support body that forms a peripheral wall of the driving apparatus 1 in the circumferential direction of the input shaft 101 to form the accommodation space for the above-described respective components of the driving apparatus 1 and support these components. The wall portion 90 forms the case main body of the case 9. In the following description, the wall portion 90 may be referred to as the case main body 90. The case main body 90 includes an opening portion 90a in the end portion on the engine E side in the axial direction of the input shaft 101 (in this embodiment, this is also the axial direction of the rotating shaft 22), and includes an opening portion 90b on the opposite side. The opening portion 90a is covered by the wall body 91.

The opening portion 90b is an opening portion that opens the accommodation space of the generator 2 and the traction motor 3. The wall portion 92 functions as a cover that covers the end portion (the opening portion 90b here) of the case main body 90. In the following description, the wall portion 92 may be referred to as the cover 92. The cover 92 is a plate-shaped or wall-shaped member, and is inferior in rigidity to the case main body 90.

<Operation Mode>

The operation mode of the driving apparatus 1 will be described. The driving apparatus 1 can be operated in an electric traveling mode in which power is supplied from a battery (not shown) to the traction motor 3 and the driving force of the traction motor 3 is used to thrust the vehicle. In this case, each of the clutches 4 and 5 is set in a disconnected state. In the electric traveling mode, if the power storage amount of the battery decreases, the engine E is driven to generate power by the generator 2, so that it is possible to charge the battery or supply power to the traction motor 3.

The driving apparatus 1 can be operated in an engine traveling mode in which a driving power of the engine E is used to thrust the vehicle. In this case, one of the clutches 4 and 5 is set in the connected state. Even in this mode, it is also possible to assist the thrust of the vehicle by driving the traction motor 3. Further, even in this mode, it is also possible to generate power by the generator 2.

If the clutch 4 is set in the connected state, the vehicle can travel at low speed, and if the clutch 5 is set in the connected state, the vehicle can travel at high speed. Since the thrust of the vehicle can be obtained using the driving force of the engine E, efficient driving is enabled.

<Structure Around Generator>

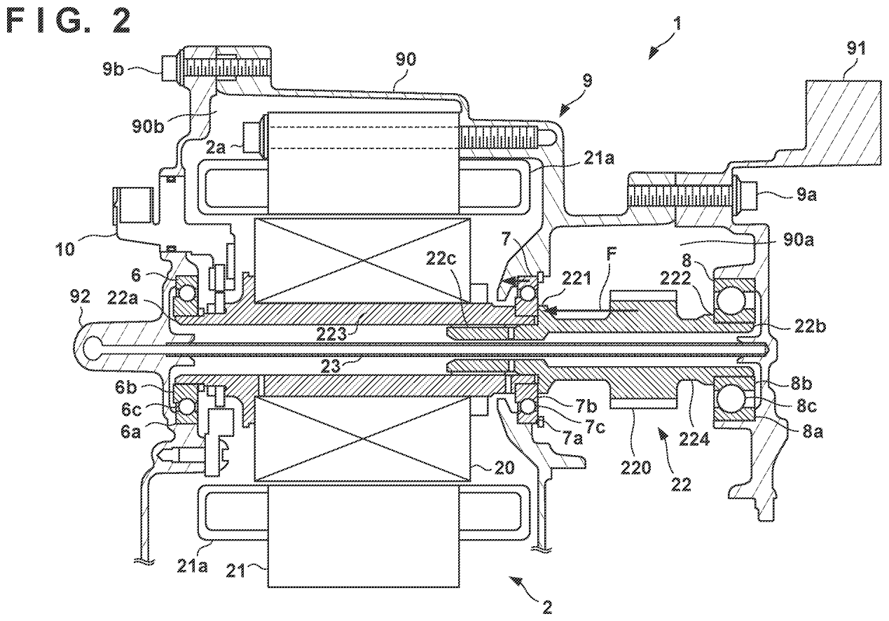

The structure around the generator 2 will be described with reference to FIG. 2. FIG. 2 is a sectional view showing the structure around the generator 2 of the driving apparatus 1. The generator 2 is accommodated in the accommodation space of the case main body 90, and the stator 21 is fixed to the case main body 90 by a plurality of bolts 2a (only one bolt 2a is shown in FIG. 2). The stator 21 includes a coil 21a.

The wall body 91 is fixed to the case main body 90 by a plurality of bolts 9a (only one bolt 9a is shown in FIG. 2), and covers the opening portion 90a of the case main body 90. The cover 92 is fixed to the case main body 90 by a plurality of bolts 9b (only one bolt 9b is shown in FIG. 2), and covers the opening portion 90b of the case main body 90. The cover 92 includes a hole portion that allows attachment of a connector unit 10. The connector unit 10 includes a sensor or the like that detects the rotation of the rotating shaft 22.

The rotating shaft 22 is a hollow shaft through which an oil supply pipe 23 passes, and includes an end portion 22a on the cover 92 side and an end portion 22b on the wall body 91 side (engine E side). The oil supply pipe 23 is extended from the cover 92 to the wall body 91, and supplies lubricating oil to the periphery of the rotating shaft 22.

The rotating shaft 22 of this embodiment includes two shaft members 223 and 224 coaxially coupled to each other in the axial direction. The shaft members 223 and 224 are coupled to each other in a coupling portion 22c. The coupling portion 22c has a spline coupling structure in which the shaft member 224 is inserted into the shaft member 223. The shaft member 223 includes the end portion 22a, and forms a portion of the rotating shaft 22 on the cover 92 side. The rotor 20 such as a permanent magnet is supported by the shaft member 223 and rotates integrally with the shaft member 223. The shaft member 224 includes the end portion 22b, and forms a portion of the rotating shaft 22 on the wall body 91 side (engine E side). The input portion 220 is a gear integrally formed with the shaft member 224.

The rotating shaft 22 is rotatably supported by the three bearings 6 to 8. The bearings 6 to 8 are rolling bearings including outer rings 6a to 8a, inner rings 6b to 8b, and rolling elements 6c to 8c, respectively. The bearing 6 is a bearing that supports the rotating shaft 22 on the end portion 22a side, and supported by the cover 92. More specifically, the outer ring 6a is fitted into a recess portion formed in the cover 92, and the rotating shaft 22 (shaft member 223) is inserted into the inner ring 6b.

The bearing 7 is a bearing that supports the rotating shaft 22 on the end portion 22b side, and supported by the case main body 90. More specifically, the outer ring 7a is fitted into a recess portion formed in the case main body 90, and the rotating shaft 22 (shaft member 223) is inserted into the inner ring 7b. The rotor 20 is located between the bearing 6 and the bearing 7. By supporting the rotating shaft 22 at positions on both sides of the rotor 20 in the axial direction and close to the rotor 20, it is possible to implement smooth rotation of the rotor 20 which is relative heavy.

The bearing 8 is a bearing that supports the rotating shaft 22 on the end portion 22b side, and supported by the wall body 91. More specifically, the outer ring 8a is fitted into a recess portion formed in the wall body 91, and the rotating shaft 22 (shaft member 224) is inserted into the inner ring 8b.

Here, transmission of the thrust load of the rotating shaft 22 will be described. A driving force of the engine E is input to the rotating shaft 22 via the input portion 220. However, since the driving force of the engine E has torque fluctuation, and the thrust-direction load of the rotating shaft 22 fluctuates. The cover 92 is a plate-shaped member whose rigidity is relatively lower than that of the case main body 90. Assuming that the thrust load is repeatedly transmitted to the cover 92 via the bearing 6 as in a conventional example, the cover 92 is repeatedly hit just like a drum, and noise is generated. In the space outside the cover 92, there is no noise source such as the engine E, and the noise of the cover 92 is easily propagated into the vehicle interior.

In order to suppress the generation of noise, in this embodiment, the rotating shaft 22 is provided with a transmission portion 221, and a thrust load F of the rotating shaft 22 acting from the end portion 22b toward the end portion 22a is transmitted to the bearing 7. The transmission portion 221 of this embodiment is integrally formed with the shaft member 224, and formed as an abutting portion that abuts against the inner ring 7b of the bearing 7. The thrust lard F is borne by the case main body 90 via the bearing 7. Therefore, the thrust-direction load of the rotating shaft 22 is hardly transmitted to the cover 92, so that the generation of noise can be suppressed. Further, in this embodiment, the shaft member 223 and the shaft member 224 are spline-coupled in the coupling portion 22c, and the both shaft members can be displaced relative to each other in the axial direction. Therefore, the transmission of the thrust-direction load from the shaft member 224 to the shaft member 223 is also suppressed, and the generation of noise caused by the vibration of the cover 92 can be further suppressed.

In addition, the inner ring 7b of the bearing 7 supports the shaft member 223 of the rotating shaft 22, and the shaft member 223 is designed to be short such that the end portion thereof on the engine E side stays in the inner ring 7b. By making the transmission portion 221 of the rotating shaft 22 abut against the inner ring 7b, it is possible to suppress the vibration without providing another bearing.

The rotating shaft 22 further includes a transmission portion 222 that transmits, to the bearing 8, the thrust load of the rotating shaft 22 acting from the end portion 22a toward the end portion 22b. The transmission portion 222 of this embodiment is integrally formed with the shaft member 224, and formed as an abutting portion that abuts against the inner ring 8b of the bearing 8. The thrust load acting from the end portion 22a toward the end portion 22b is borne by the wall body 91 via the bearing 8.

### Second Embodiment

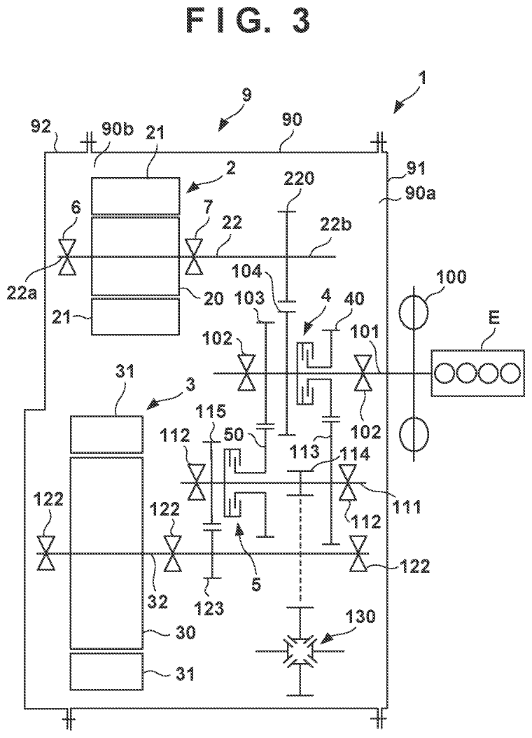

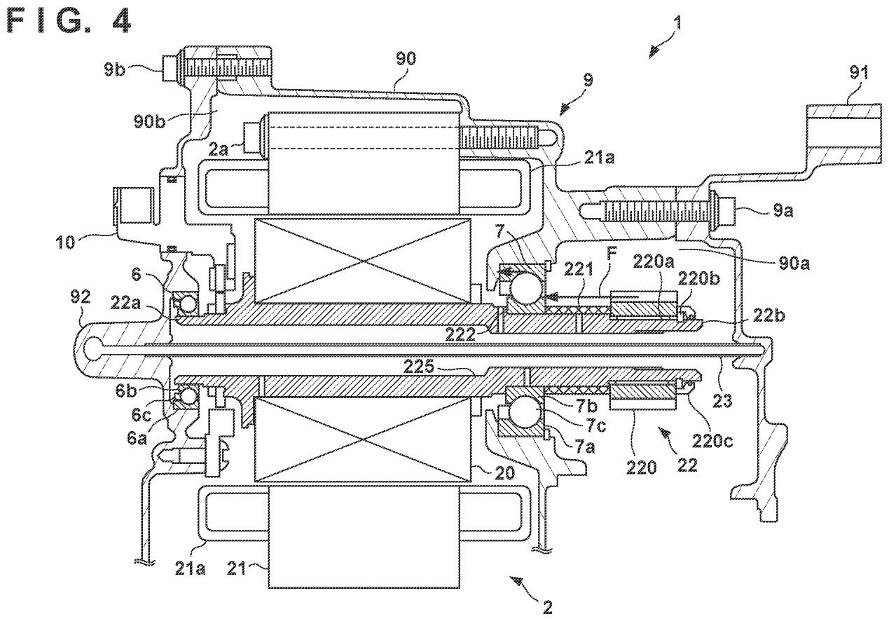

FIG. 3 is a block diagram of a driving apparatus 1 according to this embodiment, and FIG. 4 is a sectional view showing the structure around a generator 2 in this embodiment. The arrangement different from that in the first embodiment will be described below.

In this embodiment, a rotating shaft 22 is formed by one shaft member 225, and the rotating shaft 22 is rotatably supported by two bearings 6 and 7.

The bearing 6 is a bearing that supports the rotating shaft 22 on the side of an end portion 22a, and supported by a cover 92. More specifically, an outer ring 6a is fitted into a recess portion formed in the cover 92, and the rotating shaft 22 (shaft member 225) is inserted into an inner ring 6b.

The bearing 7 is a bearing that supports the rotating shaft 22 on the side of an end portion 22b, and supported by a case main body 90. More specifically, an outer ring 7a is fitted into a recess portion formed in the case main body 90, and the rotating shaft 22 (shaft member 225) is inserted into an inner ring 7b. A rotor 20 is located between the bearing 6 and the bearing 7. By supporting the rotating shaft 22 at positions on both sides of the rotor 20 in the axial direction and close to the rotor 20, it is possible to implement smooth rotation of the rotor 20 which is relatively heavy.

An input portion 220 is a gear which is a member different from the shaft member 225 and attached to the shaft member 225 in a coupling portion 220a on the end portion 22b side of the bearing 7. The coupling portion 220a is formed by spline coupling and press-fitting between the input portion 220 and the shaft member 225. By press-fitting between the input portion 220 and the shaft member 225, it is possible to eliminate rattling caused by spline backlash, so that it is possible to suppress the generation of tooth contact sound between the input portion 220 and the shaft member 225 caused by the torque fluctuation of the engine E, and the generation of noise of the cover 92 caused by the vibration of the shaft member 225 due to tooth contact. A retaining ring 220b and a cap 220c that covers the retaining ring 220b are provided on the outer side (end portion 22b side) of the input portion 220.

A transmission portion 221, which is a member different from the shaft member 225, is provide between the bearing 7 and the input portion 220. The transmission portion 221 transmits, to the bearing 7, a thrust load F of the rotating shaft 22 acting from the end portion 22b toward the end portion 22a. The transmission portion 221 is a cylindrical collar through which the shaft member 225 passes, and arranged so as to be sandwiched between the input portion 220 and the inner ring 7b of the bearing 7.

The thrust load F acting from the end portion 22b toward the end portion 22a is borne by the case main body 90 via the input portion 220, the transmission portion 221, and the bearing 7. Therefore, the thrust-direction load of the rotating shaft 22 is hardly transmitted to the cover 92, so that the generation of noise can be suppressed. Further, in this embodiment, the shaft member 225 includes no portion that abuts against the inner ring 6b in the axial direction, and the shaft member 225 can be displaced in the axial direction with respect to the inner ring 6b. In other words, the transmission of the thrust load of the shaft member 225 to the inner ring 6b is only the friction transmission between the inner ring 6b and the shaft member 225. Therefore, the transmission of the thrust-direction load from the shaft member 225 to the cover 92 is further suppressed, and the generation of noise caused by the vibration of the cover 92 can be further suppressed.

The rotating shaft 22 further includes a transmission portion 222 that transmits, to the bearing 7, the thrust load of the rotating shaft 22 acting from the end portion 22a toward the end portion 22b. The transmission portion 222 of this embodiment is integrally formed with the shaft member 225, and formed as an abutting portion that abuts against the inner ring 7b of the bearing 7. The thrust load acting from the end portion 22a toward the end portion 22b is borne by the wall body 91 via the bearing 7.

### Third Embodiment

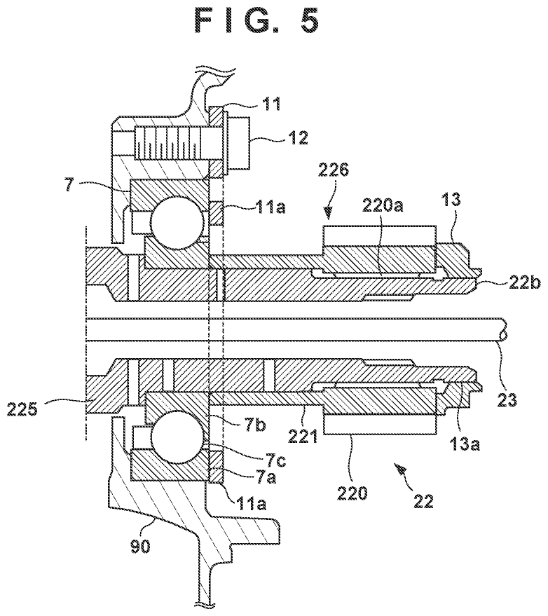

This embodiment is a modification of the second embodiment. FIG. 5 is a sectional view showing the structure around a bearing 7 in this embodiment.

A transmission portion 221 of this embodiment is a cylindrical collar as in the second embodiment, but it is integrally formed with an input portion 220, and the transmission portion 221 and the input portion 220 form a cylindrical member 226 as one part.

A coupling portion 220a of this embodiment is formed by spline coupling, but not formed by press-fitting between the input portion 220 and a shaft member 225. Instead of press-fitting, the input portion 220 (cylindrical member 226) is fixed to the shaft member 225 by fastening using a nut 13. In an end portion 22b of the shaft member 225, a thread 13a is formed in a certain range in the axial direction, and this thread is screwed into the nut 13 to fasten the input portion 220 (cylindrical member 226) to the shaft member 225.

Further, a pressing plate 11 is fixed to a case main body 90 by a plurality of bolts 12 (only one bolt 12 is shown in FIG. 5). The pressing plate 11 presses the bearing 7 against the case main body 90, thereby eliminating rattling in attachment of the bearing 7. When the bearing 7 is firmly fixed to the case main body 90, this contributes to reduction of vibration of a rotating shaft 22 and a cover 92. The pressing plate 11 includes an opening through which the rotating shaft 22 and the transmission portion 221 pass, and a pressing portion 11a that abuts against an outer ring 7a.

### Other Embodiment

In each of the above-described embodiments, the case 9 is divided into the case main body 90, the wall body 91, and the cover 92, but the dividing manner is not limited to this. For example, the case 9 may be divided in half. In this case, the case 9 may be formed by combining one part integrally including a portion of the case main body 90 and a portion of the cover 92 and the other part integrally including a remaining portion of the case main body 90 and a remaining portion of the cover 92.

### Summary of Embodiments

The above-described embodiments disclose at least vehicle driving apparatuses described below.

1. A vehicle driving apparatus (1) according to the above-described embodiment is a vehicle driving apparatus (1) that comprises

a generator (2) configured to generate power by a driving force of an engine (E),

a case (9) configured to accommodate the generator (2),

a first bearing (6) configured to rotatably support a rotating shaft (22) of the generator (2) on a side of one end portion (22a) of the rotating shaft, and

a second bearing (7) configured to rotatably support the rotating shaft (22) on a side of the other end portion (22b) of the rotating shaft (22),

wherein the case (9) includes

a first wall portion (90) that forms an accommodation space of the generator (2), and

a second wall portion (92) that covers an end portion (90b) of the first wall portion (90),

the first bearing (6) is supported by the second wall portion (92),

the second bearing (7) is supported by the first wall portion (90), and

the rotating shaft (22) comprises

an input portion (220) located on a side of the other end portion (22b) of the second bearing (7) and to which a driving force of the engine (E) is input, and

a transmission portion (221) configured to transmit, to the second bearing (7), a thrust load of the rotating shaft (22) acting from the other end portion (22b) toward the one end portion (22a).

According to this embodiment, it is possible to provide a vehicle driving apparatus that can reduce the vibration of the wall portion (92) in the arrangement in which the wall portion (92) corresponding to a cover supports the bearing (6) of the rotating shaft (22).

2. In the above-described embodiment,

the rotating shaft (22) includes a shaft member (224) integrally comprising, as the transmission portion (221), an abutting portion that abuts against the second bearing (7).

According to this embodiment, it is possible to reduce the number of parts of the rotating shaft.

3. The vehicle driving apparatus (1) according to the above-described embodiment further comprises

a third bearing (8) configured to rotatably support the rotating shaft (22) on the side of the other end portion (22b) of the second bearing (7),

wherein the rotating shaft (22) comprises

a first shaft member (223) rotatably supported by the first bearing (6), and

a second shaft member (224) coaxially coupled to the first shaft member (223) and provided with the input portion (220),

the second shaft member (224) integrally comprises, as the transmission portion (221), an abutting portion that abuts against the second bearing (7), and

the second shaft member (224) integrally comprises a second transmission portion (222) configured to transmit, to the third bearing (8), the thrust load of the rotating shaft (22) acting from the one end portion (22a) toward the other end portion (22b).

According to this embodiment, it is possible to bear the thrust load bidirectionally in the axial direction of the rotating shaft (22) without largely deteriorating the part assemblability.

4. In the above-described embodiment,

the input portion (220) is a gear integrally formed with the second shaft member (224).

According to this embodiment, it is possible to reduce the number of parts of the rotating shaft.

5. In the above-described embodiment,

the input portion (220) is located between the second bearing (7) and the third bearing (8).

According to this embodiment, it is possible to support both sides of the input portion (220), so that the rotating shaft (22) can be rotated more smoothly.

6. In the above-described embodiment,

the rotating shaft (22) comprises

a shaft member (225) provided with a gear as the input portion (220), and

a cylindrical collar as the transmission portion (221) sandwiched between the gear (220) and the second bearing (7).

According to this embodiment, the case main body (90) can bear the thrust load of the rotating shaft (22) via the second bearing (7) with a relatively simple arrangement.

7. In the above-described embodiment,

the shaft member (225) integrally comprises a second transmission portion (222) configured to transmit, to the second bearing (7), the thrust load of the rotating shaft (22) acting from the one end portion (22a) toward the other end portion (22b).

According to this embodiment, it is possible to bear the thrust load bidirectionally in the axial direction of the rotating shaft (22) without largely deteriorating the part assemblability.

8. In the above-described embodiment,

the gear (220) is press-fitted with the shaft member (225).

According to this embodiment, it is possible to suppress the generation of tooth contact between the gear (220) and the shaft member (225).

9. In the above-described embodiment,

the rotating shaft (22) comprises

a shaft member (225) supported by the first bearing and the second bearing, and

a cylindrical member (226) fixed to the shaft member (225) and integrally comprising the input portion (220) and the transmission portion (221).

According to this embodiment, it is possible to reduce the number of parts of the rotating shaft. In addition, the thrust load caused by the torque fluctuation of the driving force of the engine can be directly transmitted by the second bearing.

10. In the above-described embodiment,

a rotor (20) of the generator (2) is supported by the rotating shaft (22) between the first bearing (6) and the second bearing (7), and

a stator (21) of the generator (2) is supported by the first wall portion (90).

According to this embodiment, the rotor (20) can be rotated smoothly, and the stator (21) can be firmly supported by the first wall portion (90).

11. The vehicle driving apparatus (1) according to the above-described embodiment comprises

a traction motor (3) configured to exert a driving force to be transmitted to a wheel, and

a clutch (4, 5) configured to connect/disconnect transmission of the driving force of the engine (E) to the wheel.

According to this embodiment, it is possible to select one of traveling using the driving force of the traction motor (3) and traveling using the driving force of the engine (E).

The invention is not limited to the foregoing embodiments, and various variations/changes are possible within the spirit of the invention.

What is claimed is:

1. A vehicle driving apparatus comprising:
a generator configured to generate power by a driving force of an engine;
a case configured to accommodate the generator;
a first bearing configured to rotatably support a rotating shaft of the generator on a side of one end portion of the rotating shaft; and
a second bearing configured to rotatably support the rotating shaft on a side of the other end portion of the rotating shaft,
wherein the case includes
a first wall portion that forms an accommodation space of the generator, and
a second wall portion that covers an end portion of the first wall portion,
the first bearing is supported by the second wall portion,
the second bearing is supported by the first wall portion, and
the rotating shaft includes
an input portion located on a side of the other end portion of the second bearing and to which a driving force of the engine is input, and
a transmission portion configured to transmit, to the second bearing, a thrust load of the rotating shaft acting from the other end portion toward the one end portion.

2. The apparatus according to claim 1, wherein
the rotating shaft includes a shaft member integrally including, as the transmission portion, an abutting portion that abuts against the second bearing.

3. The apparatus according to claim 1, further comprising a third bearing configured to rotatably support the rotating shaft on the side of the other end portion of the second bearing,
wherein the rotating shaft includes
a first shaft member rotatably supported by the first bearing, and
a second shaft member coaxially coupled to the first shaft member and provided with the input portion,
the second shaft member integrally comprises, as the transmission portion, an abutting portion that abuts against the second bearing, and
the second shaft member integrally comprises a second transmission portion configured to transmit, to the third bearing, the thrust load of the rotating shaft acting from the one end portion toward the other end portion.

4. The apparatus according to claim 3, wherein
the input portion is a gear integrally formed with the second shaft member.

5. The apparatus according to claim 3, wherein
the input portion is located between the second bearing and the third bearing.

6. The apparatus according to claim 1, wherein
the rotating shaft includes
a shaft member provided with a gear as the input portion, and
a cylindrical collar as the transmission portion sandwiched between the gear and the second bearing.

7. The apparatus according to claim 6, wherein
the shaft member integrally comprises a second transmission portion configured to transmit, to the second bearing, the thrust load of the rotating shaft acting from the one end portion toward the other end portion.

8. The apparatus according to claim 6, wherein
the gear is press-fitted with the shaft member.

9. The apparatus according to claim 1, wherein
the rotating shaft includes
a shaft member supported by the first bearing and the second bearing, and
a cylindrical member fixed to the shaft member and integrally including the input portion and the transmission portion.

10. The apparatus according to claim 1, wherein
a rotor of the generator is supported by the rotating shaft between the first bearing and the second bearing, and
a stator of the generator is supported by the first wall portion.

11. The apparatus according to claim 1, further comprising:
a traction motor configured to exert a driving force to be transmitted to a wheel; and
a clutch configured to connect/disconnect transmission of the driving force of the engine to the wheel.
